(19) United States
(12) Patent Application Publication
(10) Pub. No.: US 2025/0132320 A1
(43) Pub. Date: Apr. 24, 2025

(54) LOW CONCENTRATION ADDITIVES FOR IRON NEGATIVE ELECTRODES

(71) Applicant: FORM ENERGY, INC., Somerville, MA (US)

(72) Inventors: Zachariah NORMAN, Lincoln, MA (US); Annelise Christine THOMPSON, Somerville, MA (US); Cleo KYRIAKIDES, Somerville, MA (US); Michael Andrew GIBSON, Philadelphia, PA (US); Sarah FRISCO, Somerville, MA (US); David HOOKE, Seattle, WA (US); Rishav CHOUDHURY, Somerville, MA (US); Catherine Kingston GROSCHNER, Somerville, MA (US); Craig STRINGER, Somerville, MA (US)

(21) Appl. No.: 18/922,247

(22) Filed: Oct. 21, 2024

Related U.S. Application Data
(60) Provisional application No. 63/591,625, filed on Oct. 19, 2023.
(60) Provisional application No. 63/591,606, filed on Oct. 19, 2023.
(60) Provisional application No. 63/607,498, filed on Dec. 7, 2023.

(51) Int. Cl. H01M 4/38; H01M 4/02; H01M 4/04; H01M 4/36; H01M 4/62

(52) U.S. Cl. CPC H01M 4/38; H01M 4/0416; H01M 4/362; H01M 4/628; H01M 2004/021; H01M 2004/027

(57) ABSTRACT

According to an aspect, an electrochemical cell may include an electrolyte and an anode in the electrolyte, the anode including an iron-containing active material, at least one of the anode and the electrolyte including an additive reactive to inhibit hydrogen evolution in a charge state and in a resting state of the electrochemical cell, and the additive in a concentration greater than about 10 and less than about 10,000 atoms of additive per million atoms iron of the iron-containing active material.

### CROSS-REFERENCE TO RELATED APPLCIATIONS

This application claims priority to U.S. Provisional App. 63/591,625, filed Oct. 19, 2023, to U.S. Provisional App. 63/591,606, filed Oct. 19, 2023, and to U.S. Provisional App. 63/607,498, filed Dec. 7, 2023, with the entire contents of each of these applications hereby incorporated herein by reference.

### BACKGROUND

Energy storage technologies are playing an increasingly important role in electric power grids. These energy storage assets provide smoothing to better match generation and demand on a grid. The services performed by energy storage devices are beneficial to electric power grids across multiple time scales, from milliseconds to years. Today, energy storage technologies exist that can support timescales from milliseconds to hours, but there is a need for long and ultralong (collectively, >8 h) energy storage systems. Of benefit are potentially low-cost rechargeable battery chemistries that can enable long duration large scale energy storage.

### SUMMARY

According to an aspect, an electrochemical cell may include an electrolyte, and an anode in the electrolyte, the anode including an iron-containing active material, at least one of the anode and the electrolyte including an additive reactive to inhibit hydrogen evolution in a charge state and in a resting state of the electrochemical cell, and the additive in a concentration greater than about 10 and less than about 10,000 atoms of additive per million atoms iron of the iron-containing active material.

In certain implementations, the additive may include one or more non-ferrous metal components. For example, the one or more non-ferrous metal components may include Sb, Bi, Cd, Hg, In, Cu, Pb, Ga, Sc, Ge, or combinations thereof. Further, or instead, each of the one or more non-ferrous metal components may be in one of an elemental form, an oxide, a hydroxide, an oxyhydroxide, a nitrate, an acetate, a sulfate, a phosphate, a carbonate, a chloride, or a sulfide form. Additionally, or alternatively, the additive may include an alloy of the one or more non-ferrous metal components. The alloy of the one or more non-ferrous metal components may include an indium-zinc sulfide alloy.

In some implementations, the additive may be dispersed in the electrolyte. As an example, the additive may include lead oxide dissolved in the electrolyte. In certain instances, greater than 0 wt % and less than 0.005 wt % of lead oxide may be dissolved in the electrolyte. Further, or instead, the additive may include indium nitrate dissolved in the electrolyte. For example, greater than 0 mM and less than 20 mM of indium nitrate may be dissolved in the electrolyte. Still further, or instead, the additive may include lead acetate dissolved in the electrolyte. For example, the additive may include greater than 0 mM and less than 0.0050 mM lead acetate. Further, or instead, the electrochemical cell of claim 7, wherein the additive includes antimony acetate. As an example, the additive may include greater than 0 mM and less than 0.000050 mM antimony acetate.

In certain implementations, the additive may be supported on the anode, and the additive is dissolvable from the anode into the electrolyte during cycling of the electrochemical cell between a charge mode and a discharge mode.

In some implementations, the additive may be wetted on the iron-containing active material of the anode.

In certain implementations, the additive may be disposed in the anode, and a highest concentration of the additive is along a surface of the anode.

In some implementations, the iron-containing active material of the anode may at least partially defines a porous structure. For example, at least a portion of the iron-containing active material of the anode may be sintered. In some instances, the additive may be disposed in the anode, and a highest volumetric concentration of the additive in the anode is along a surface of the anode. Further, or instead, the additive and the iron-containing active material may collectively define the porous structure. In certain instances, the additive may include lead sulfide. Still further, or instead, the iron-containing active material may include iron powder. In some instances, the electrochemical cell may further include a binder in a mixture including the additive and the iron powder. In certain instances, the additive may include indium metal mixed with the iron powder. As a specific example, the additive may further include zinc sulfide mixed with the iron powder. In some instances, the additive may include greater than 200 mol indium/million mol iron and less than 2000 mol indium/million mol iron. In certain instances, the additive may include indium oxide mixed with the iron powder. In some instances, the additive may include a granulate mixed with the iron powder. The granulate may include indium metal. Further, or instead, the granulate may include lead oxide. Still further, or instead, the additive may include zinc sulfide.

In certain implementations, the electrolyte may include potassium hydroxide (KOH), sodium hydroxide, lithium hydroxide (LiOH), or a combination thereof. For example, the electrolyte may include 5.95M KOH and 0.05M LiOH. Further, or instead, the electrolyte may include 4-8 M potassium hydroxide (KOH) and 20-80 mM stannate ions. Still further, or instead, the electrolyte may include 10-120 mM aluminate ions. Still further, or instead, the electrolyte includes indium nitrate. Further, or instead, the electrolyte may include lead oxide.

In some implementations, the additive may reduce a rate of self-discharge of the electrochemical cell by at least 10 percent compared to the rate of self-discharge of the electrochemical cell without the additive.

In certain implementations, a mean percentage capacity of the electrochemical cell lost per day of may be greater than zero and less than 4 percent.

In some implementations, specific hydrogen current density of the electrochemical cell may be greater than zero and less than 0.5 mA/g, measured over a 48 hour rest at top of charge of the electrochemical cell.

In some implementations, the additive may be substantially uniformly distributed in the anode with volumetric concentration of the additive in the anode varying by less than ±20 percent within the anode. As an example, the additive may include lead sulfide. Further, or instead, the additive may include lead oxide.

In certain implementations, the electrochemical cell may further include a positive electrode in ionic communication with the anode via the electrolyte.

According to another aspect, a method of fabricating an electrode for an electrochemical cell may include forming a feedstock including an iron-containing active material and at least one of an additive or a precursor of the additive, the additive reactive to inhibit hydrogen evolution from the electrode under electrochemical cycling; processing the feedstock into a composite, the additive distributed relative to the iron-containing active material in the composite, and additive in a concentration greater than about 10 and less than about 10,000 atoms of additive per million atoms of iron in the composite; and shaping the composite into a green body of the electrode.

In certain implementations, forming the feedstock may include mixing the iron-containing active material and the additive together. For example, mixing the iron-containing active material and the additive together may include tumble mixing the iron-containing active material and the additive together.

In some implementations, forming the feedstock may include mixing a powder of the iron-containing active material with the additive to form a mixture and heating the mixture to an elevated temperature greater than a melt temperature of the additive and less than a forging temperature of the iron-containing active material to form an additive-containing alloy. As an example, the powder may be iron powder and the additive is indium metal, and heating the mixture to the elevated temperature includes heating the mixture to 600° C. Further, or instead, processing the feedstock may include mixing the additive-containing alloy with an additional amount of the iron-containing active material such that concentration of the additive in the composite is greater than about 10 and less than about 10,000 atoms of additive per million atoms of iron in the composite.

In certain implementations, processing the feedstock into the composite may include wetting the additive on the iron-containing active material. For example, wetting the additive on the iron-containing active material may include heating the feedstock to an elevated temperature greater than a melt temperature of the additive and less than a forging temperature of iron. In certain instances, the additive may include indium metal, and the elevated temperature is 200° C. or greater and 1200° C. or less. Further, or instead, wetting the additive on the iron-containing active material may include heating the feedstock to an elevated temperature greater than a reduction temperature of the precursor of the additive and less than a forging temperature of iron. As an example, the precursor of the additive may include indium hydroxide, and the elevated temperature is 200° C. or greater and 1200° C. or less.

In some implementations, forming the feedstock may include treating the iron-containing active material with a binder and, with the iron-containing active material treated with the binder, combining the additive with the iron-containing active material. For example, combining the additive with the iron-containing active material treated with the binder may include high shear mixing the additive with the iron-containing active material treated with the binder.

In some implementations, shaping the composite into the green body of the electrode may include introducing the composite into a die.

In some implementations, the method may further include sintering the green body of the electrode.

According to yet another aspect, a method of fabricating an electrode for an electrochemical cell, the method comprising forming a green body including an iron-containing active material, positioning an additive on at least one surface of the green body, the additive reactive to inhibit hydrogen evolution from the electrode under electrochemical operation; and with the additive positioned on the at least one surface of the green body, wicking the additive into the green body.

In certain implementations, positioning the additive on the at least one surface of the green body may include positioning a foil of the additive on the at least one surface of the green body.

In some implementations, positioning the additive on the at least one surface of the green body may include positioning a powder of the additive on the at least one surface of the green body.

In certain implementations, the additive may include indium metal.

In some implementations, wicking the additive into the green body may include heating the additive and the green body to an elevated temperature greater than a melt temperature of the additive and less than a forging temperature of the iron-containing active material of the green body. For example, the additive may be indium metal, and the elevated temperature is 200° C. or greater and 1200° C. or less.

According to yet another aspect, a method of static discharge testing of an electrochemical cell may include cycling the electrochemical cell through at least two baseline cycles, each baseline cycle including charging the electrochemical cell from a lower voltage limit to a predetermined target capacity and discharging the electrochemical cell from the predetermined target capacity to the lower voltage limit, measuring a first Coulombic efficiency of the electrochemical cell following the at least two baseline cycles, cycling the electrochemical cell through a comparison cycle including charging the electrochemical cell from the lower voltage limit to the predetermined target capacity, with the electrochemical cell charged to the predetermined target capacity, interrupting electric current to the electrochemical cell for a predetermined rest period, and at the end of the predetermined rest period, discharging the electrochemical cell to the lower voltage limit, measuring a second Coulombic efficiency following the comparison cycle, and based on the first Coulombic efficiency and the second Coulombic efficiency, determining a change in discharge capacity of the electrochemical cell.

In some implementations, the electrochemical cell may include an iron electrode. For example, the electrochemical cell may include an air electrode.

In some implementations, the predetermined rest period may be 24 hours or more and 72 hours or less (e.g., 48 hours)

In certain implementations, determining the change in the discharge capacity of the electrochemical cell may include determining a rate of discharge capacity loss over time of the predetermined rest period.

### DESCRIPTION OF THE DRAWINGS

FIG. 1A is a schematic representation of an electrochemical cell.

FIG. 1B is a schematic representation of a rechargeable battery.

FIG. 2 is a close-up view of a portion of the anode of the electrochemical cell of FIG. 1A in an implementation in which the anode includes an additive supported in a porous structure defined by an iron-containing active material.

FIG. 3 is a close-up view of a portion of the anode of the electrochemical cell of FIG. 1A in an implementation in which the anode includes an additive having a highest volumetric concentration along a surface of a porous structure at least partially defined by an iron-containing material.

FIG. 4 is a close-up view of a portion of the anode of the electrochemical cell of FIG. 1A in an implementation in which the anode includes an additive-containing alloy supported in a porous structure defined by the iron-containing active material.

FIG. 5 is a flowchart of an exemplary method of fabricating an electrode for an electrochemical cell.

FIG. 6 is a scanning electron microscope (SEM) image of an iron powder and indium metal alloy combined with a remainder of iron active material to form a green body.

FIG. 7 is a scanning electron microscope (SEM) image of indium metal (light spots) wetted onto iron.

FIG. 8 is a scanning electron microscope (SEM) image of indium hydroxide (light spots) wetted onto iron.

FIG. 9 is a scanning electron microscope (SEM) image of binder-treated iron treated combined, via mixing, with indium metal (light spot).

FIG. 10 is a scanning electron microscope (SEM) image of binder-treated iron combined, via mixing, with indium hydroxide (indicated by arrows).

FIG. 11 is a flowchart of an exemplary method of fabricating an electrode of an electrochemical cell.

FIG. 12 is a graph of experimentally measured Coulombic efficiency fraction as a function of cycle number for a baseline electrochemical cell without an additive compared to an electrochemical cell including indium nitrate in an electrolyte.

FIG. 13 is a flowchart of an exemplary method of static discharge testing of an electrochemical cell.

FIG. 14 is a bar chart of mean specific capacity lost (mAH/g) and mean percentage capacity loss per day experimentally determined according to the method FIG. 13 for a baseline electrochemical cell without an additive compared to an electrochemical cell including indium nitrate in an electrolyte.

FIG. 15 is a bar chart of experimentally determined volume of hydrogen evolution for a baseline example of atomized iron powder in 6.5 M potassium hydroxide (KOH) as compared to atomized iron powder in 0.4 mM indium nitrate and 6.5 M potassium hydroxide (KOH).

FIG. 16 is a graph of experimentally measured Coulombic efficiency fraction as a function of cycle number for a baseline electrochemical cell without an additive compared to an electrochemical cell including a sintered anode of indium metal and iron and to an electrochemical cell including a sintered anode of indium oxide and iron.

FIG. 17 is a bar chart of mean specific capacity lost (mAH/g) and mean percentage capacity loss per day experimentally determined according to the method FIG. 13 for a baseline electrochemical cell without an additive compared to an electrochemical cell including a sintered anode of indium metal and iron and compared to an electrochemical cell including a sintered anode of indium oxide and iron.

FIG. 18 is a bar chart of experimentally determined mean specific hydrogen current density (mA/g) for a baseline electrochemical cell without an additive compared to an electrochemical cell including a sintered anode of indium metal and iron.

FIG. 19 is a bar chart of experimentally determined volume of hydrogen evolution for a baseline example of atomized iron powder in 6.5 M potassium hydroxide (KOH) as compared to atomized powder and indium hydroxide (1000 ppm number mol indium/million mol iron) in 6.5 M potassium hydroxide (KOH).

FIG. 20 experimentally measured Coulombic efficiency fraction as a function of cycle number for a baseline electrochemical cell without an additive compared to an electrochemical cell including an electrolyte with lead acetate as an additive and compared to an electrochemical cell including lead sulfide as an additive in the anode.

FIG. 21 is a bar chart of mean specific capacity lost (mAH/g) and mean percentage capacity loss per day experimentally determined according to the method FIG. 13 for a baseline electrochemical cell without an additive compared to an electrochemical cell including an electrolyte with lead acetate as an additive.

FIG. 22 is a graph of cyclic voltammetry results of a three-electrode set-up with an iron foil using a baseline electrolyte without an additive compared to the same electrolyte with 0.001 wt % lead oxide added.

FIG. 23 is a graph of experimentally determined total discharge capacity as a function of cycle number for a baseline electrochemical cell without an additive compared to an electrochemical cell including an electrolyte with antimony acetate as an additive.

Like reference symbols in the various drawings indicate like elements.

### DETAILED DESCRIPTION

Embodiments will be described in detail with reference to the accompanying drawings. Wherever possible, the same reference numbers will be used throughout the drawings to refer to the same or like parts. References made to particular examples and implementations are for illustrative purposes and are not intended to limit the scope of the claims. The following description of the embodiments of the disclosure is not intended to limit the disclosure to these embodiments but rather to enable a person skilled in the art to make and use this disclosure. Unless otherwise noted, the accompanying drawings are not drawn to scale.

As used herein unless specified otherwise, the recitation of ranges of values herein is merely intended to serve as a shorthand method of referring individually to each separate value falling within the range. Unless otherwise indicated herein, each individual value within a range is incorporated into the specification as if it were individually recited herein.

The following examples are provided to illustrate various embodiments of the present systems and methods of the present disclosure. These examples are for illustrative purposes, may be prophetic, and should not be viewed as limiting, and do not otherwise limit the scope of the present disclosure.

The various embodiments of systems, equipment, techniques, methods, activities, and operations set forth in this specification may be used for various other activities and in other fields in addition to those set forth herein. Additionally, these embodiments, for example, may be used with other equipment or activities that may be developed in the future and with existing equipment or activities which may be modified, in-part, based on the teachings of this specification. Further, the various embodiments and examples set forth in this specification may be used with each other, in whole or in part, and in different and various combinations. Thus, for example, the configurations provided in the various embodiments of this specification may be used with each other. Thus, the configurations provided in the various embodiments of this specification may be used with each other. For example, the components of an embodiment having A, A′ and B and the components of an embodiment having A″, C and D can be used with each other in various combination, e.g., A, C, D, and A. A″ C and D, etc., in accordance with the teaching of this Specification. The scope of protection afforded the present disclosure should not be limited to a particular embodiment, configuration or arrangement that is set forth in a particular embodiment, example, or in an embodiment in a particular figure.

As used herein, unless stated otherwise, room temperature is 25° C. And, standard temperature and pressure is 25° C. and 1 atmosphere. Unless expressly stated otherwise all tests, test results, physical properties, and values that are temperature dependent, pressure dependent, or both, are provided at standard ambient temperature and pressure.

Unless otherwise specified or made clear from the context, all references to mean particle size herein shall be understood to refer to mean particle size on a weight percentage basis. Thus, some references to mean particle size herein may occasionally omit specific mention of “weight percentage basis” for the sake of clarity and readability.

Embodiments of the present disclosure include apparatuses, systems, and methods for long-duration, and ultra-long-duration energy storage. Herein, “long duration” and/or “ultra-long duration” may refer to periods of energy storage of 8 hours or longer, such as periods of energy storage of 8 hours, periods of energy storage ranging from 8 hours to 20 hours, periods of energy storage of 20 hours, periods of energy storage ranging from 20 hours to 24 hours, periods of energy storage of 24 hours, periods of energy storage ranging from 24 hours to a week, periods of energy storage ranging from a week to a year (e.g., such as from several days to several weeks to several months), etc. In other words, “long duration” and/or “ultra-long duration” energy storage devices or systems may refer to energy storage devices or systems that may be configured to store energy over time spans of days, weeks, or seasons. For example, the energy storage devices or systems may be configured to store energy generated by solar cells during the summer months, when sunshine is plentiful and solar power generation exceeds power grid requirements, and discharge the stored energy during the winter months, when sunshine may be insufficient to satisfy power grid requirements.

According to other embodiments, the present invention includes apparatus, systems, and methods for energy storage at shorter durations of less than about 8 hours. For example, the electrochemical cells may be configured to store energy generated by solar cells during the diurnal cycle, where the solar power generation in the middle of the day may exceed power grid requirements, and discharge the stored energy during the evening hours, when the sunshine may be insufficient to satisfy power grid requirements. As another example, said invention may include energy storage used as backup power when the electricity supplied by the power grid is insufficient, for installations including homes, commercial buildings, factories, hospitals, or data centers, where the required discharge duration may vary from a few minutes to several days.

An electrochemical cell, such as a battery, stores electrochemical energy by using a difference in electrochemical potential generating a voltage difference between the positive and negative electrodes. This voltage difference produces an electric current if the electrodes are connected by a conductive element. In a battery, the negative electrode and positive electrode are connected by external and internal resistive elements in series. Generally, the external element conducts electrons, and the internal element (electrolyte) conducts ions. Because a charge imbalance cannot be sustained between the negative electrode and positive electrode, these two flow streams must supply ions and electrons at the same rate. In operation, the electronic current can be used to drive an external device. A rechargeable battery can be recharged by applying an opposing voltage difference that drives an electric current and ionic current flowing in the opposite direction as that of a discharging battery in service.

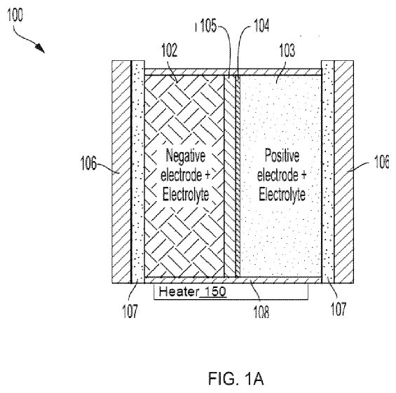

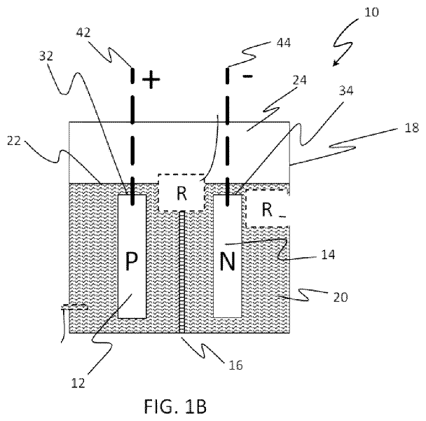

Referring now to FIG. 1A, an electrochemical cell 100 (e.g., a battery) may include a negative electrode 102 (also referred to herein as an anode) separated from a positive electrode 103 by a separator 104. The separator 104 may be supported, for example, by a mesh 105 (e.g., a polypropylene mesh) and a frame 108 (e.g., polyethylene or polypropylene) of the electrochemical cell 100. Current collectors 107 may be associated with respective ones of the negative electrode 102 and positive electrode 103 and supported by backing plates 106 (e.g., polyethylene or polypropylene backing plates). In some embodiments, the temperature of the electrochemical cell 100 may be controlled, such as by insulation around the electrochemical cell 100 and/or by a heater 150. For example, the heater 150 may raise the temperature of the electrochemical cell 100 and/or specific components of the cell, such as an electrolyte infiltrated in the negative electrode 102 and the positive electrode 103. The negative electrode 102 and the positive electrode 103 may be in ionic communication with one another via the electrolyte. Unless otherwise specified or made clear from the context, the electrolyte may be any one or more of the various different electrolytes described herein. As an example, the electrolyte may be an aqueous solution. In certain embodiments the electrolyte may be an alkaline solution (pH>10). In certain embodiments, the electrolyte may be a near-neutral solution (10>pH>4).

The electrochemical cell 100 is merely an example of one electrochemical cell configuration according to various embodiments and is not intended to be limiting. Other configurations, such as electrochemical cells with different type meshes and/or without the mesh 105, electrochemical cells with different type frames and/or without the frame 108, electrochemical cells with different type current collectors and/or without the current collectors 107, electrochemical cells with reservoir structures, electrochemical cells with different type backing plates and/or without the backing plates 106, electrochemical cells with different type insulation and/or without insulation, and/or electrochemical cells with different type heaters and/or without the heater 150, may be substituted for the example configuration of the electrochemical cell 100 shown in FIG. 1A and other configurations are in accordance with the various embodiments.

In some embodiments, a plurality of electrochemical cells 100 in FIG. 1A may be connected electrically in series to form a stack. In certain other embodiments, a plurality of electrochemical cells 100 may be connected electrically in parallel. In certain other embodiments, the electrochemical cells 100 are connected in a mixed series-parallel electrical configuration to achieve a favorable combination of delivered current and voltage.

Referring now to FIG. 1B, a rechargeable battery 10 may include a positive electrode 12, a negative electrode 14 (also referred to herein as an anode), and a separator 16 within a container 18 filled with electrolyte 20 to a level 22 at least as high as the respective tops 32, 34 of the electrodes 12, 14. The space above the level 22 of the electrolyte 20 may be referred to as the headspace 24. The positive electrode 12 may be ionic communication with the negative electrode 14 via the electrolyte 20. The positive electrode 12 may be electrically connected to a positive terminal 42 of the rechargeable battery 10 and may contain active material that may undergo reduction reactions during discharging and oxidation reactions during charging. The negative electrode 14 may be electrically connected to a negative terminal 44 of the rechargeable battery 10 and may contain active material that may undergo oxidation reactions during discharging and reduction reactions during charging of the rechargeable battery 10. The rechargeable battery 10 in FIG. 1B is merely an example of one electrochemical cell according to various embodiments and is not intended to be limiting.

In various embodiments, the electrolyte 20 may be an aqueous or non-aqueous alkaline, neutral, or acidic solution. For example, the electrolyte solution may contain potassium hydroxide (KOH), sodium hydroxide (NaOH), lithium hydroxide (LiOH) or combinations of these. As an example, the electrolyte may include 5.95M potassium hydroxide (KOH) and 0.05M lithium hydroxide (LiOH). Further, or instead, the electrolyte may include 4-8 M potassium hydroxide (KOH) and 20-80 mM stannate ions. Still further, or instead, the electrolyte includes 10-120 mM aluminate ions.

In some embodiments, the rechargeable battery 10 may include a separator 16 that allows transfer of ions between the electrodes 12, 14 via the electrolyte. In some embodiments, a separator may be chosen based on an ability to allow selective transfer of desired molecules or materials while substantially limiting or preventing transfer of undesired molecules or materials. For example, some separator membranes are ion-selective and allow the transfer of negative (or positive) ions while substantially preventing transfer of positive (or negative) ions. In other examples, separator materials may be chosen based on an ability to allow or prevent the cross-over of gas bubbles from one side (associated with one electrode) to the opposite side (associated with the counter-electrode).

In various embodiments, the container 18 may be made of any suitable materials and construction capable of containing the electrolyte, electrodes, and at least a minimum amount of gas pressure. For example, the container 18 may be made of metals, plastics, composite materials, or others. In some embodiments, the container 18 may be sealed so as to prevent the escape of any gases generated during operation of the battery.

In some embodiments, the container 18 may include a pressure relief valve to allow release of gases when a gas pressure within the container 18 exceeds a pre-determined threshold.

While the electrodes 12, 14 are shown substantially spaced apart in the figures, in some embodiments the electrodes may be very close to one another or even compressed against one another with a separator 16 in between. Furthermore, although the figures may illustrate a single instance of the positive electrode 12 and a single instance of the negative electrode 14, battery systems within the scope of the present disclosure may also include two or more positive electrodes 12 and/or two or more negative electrodes 14.

Referring now to FIGS. 1A and 1B, it shall be generally understood that the negative electrode 102 of the electrochemical cell 100 and/or the negative electrode 14 of the rechargeable battery 10 may include metal or metal oxides such as iron, zinc, cadmium, or other metals and/or oxides or hydroxides of these or other metals, unless otherwise specified or made clear from the context. Further, it shall be generally understood that the negative electrode 102 of the electrochemical cell 100 and the negative electrode 14 of the rechargeable battery 10 have similar or identical features, unless otherwise indicated or made clear from the context and, for the sake of efficient description, these are not described separately for each negative electrode. Thus, in view of the foregoing, embodiments in the description that follows are described in the context of the negative electrode 14 and, more specifically, in the context of the negative electrode 14 as an iron negative electrode. Accordingly, the negative electrode 14 shall be referred to hereinafter as “the iron negative electrode 14” and all such references shall be understood to be intended to encompass references to other types of active metals described herein and to other negative electrodes described herein (e.g., to the negative electrode 102), unless otherwise specified or made clear from the context.

### Low-Concentration Additives

Having described certain aspects of the electrochemical cell 100 and the rechargeable battery 10, attention is now directed to the description of certain additives (e.g., an additive containing one or more non-ferrous metal atoms) that may be added in low concentrations to improve performance of the negative electrode 102 of the electrochemical cell 100 and/or the negative electrode 14 of the rechargeable battery 10. In particular, the additives described herein generally alter (increase) the required overpotential for hydrogen evolution and, therefore, may alternatively be referred to herein as hydrogen evolution reaction (HER) inhibitors. As compared to the use of a given additive in higher concentrations, the use of such an additive in low concentrations may reduce the cost, complexity, and/or safety precautions associated with fabrication of the electrochemical cell 100 while still providing performance benefits associated with the additive. Further, or instead, as compared to the use of a given additive in higher concentrations, the use of such an additive in low concentrations may provide performance benefits while reducing the likelihood of negative performance impacts that may be associated with high concentrations of the additive. Stated differently, certain materials that may poison or otherwise negatively impact the electrochemical cell 100 in high concentrations may be useful as performance-enhancing additives at low concentrations in the electrochemical cell 100.

As used herein, unless otherwise specified or made clear from the context, the term “low concentration” shall be understood to refer to concentrations of greater than 10 and less than 10,000 atoms of additive atom per million iron atoms. Thus, consistent with this usage and for the sake of convenience, “ppm” or “parts per million” shall be understood to refer to the number of additive atoms per million iron atoms. Further, unless otherwise specified or made clear from the context, the terms “HER inhibitor” and “additive reactive to inhibit hydrogen evolution in a charge sate and in a resting state of the electrochemical cell” shall be understood to be interchangeable herein.

Further, certain aspects of low concentration additives are described herein in the context of examples of material including atoms antimony (Sb), indium (In), or lead (Pb). It shall be understood that this is for the sake of clear and efficient description. That is, discussion of one or more examples shall be understood to be applicable to other non-ferrous metals (e.g., bismuth (Bi), cadmium (Cd), mercury (Hg), copper (Cu), gallium (Ga), scandium (Sc), and/or germanium (Ge)), unless otherwise specified or made clear from the context. Similarly, unless a contrary intent is explicitly stated, use of the term “additive” herein shall be understood to include material including atoms of any one or more of Sb, Bi, Cd, Hg, In, Pb, Ga, Sc, Cu, and/or Ge. Further, or instead, each of the of the one or more non-ferrous components of the additive may be one of an elemental form, an oxide, a hydroxide, an oxyhydroxide, a nitrate, an acetate, a sulfate, a phosphate, a carbonate, a chloride, or a sulfide form and, further or instead, may include an alloy of one or more non-ferrous metal components (e.g., an indium-zinc sulfide alloy). Unless otherwise indicated or made clear from the context, each of these forms of the one or more non-ferrous components shall be understood to be interchangeable in certain aspects of the electrochemical cells and fabrication techniques described herein. Thus, for the sake of clear and efficient description, the recitation of each of these forms is not repeated with each discussion of the term “additive.” To the extent specific formulations of the additive are described below, it shall be appreciated that this is for the sake of highlighting certain aspects of the particular additive or class of additive and is not necessarily to the exclusion of other additives or classes of additives.

In general, iron electrodes in aqueous caustic for energy storage applications exhibit limitations in Coulombic and energy efficiency due to hydrogen evolution reactions (HER) during charge and resting states. Additives described herein may alter (increase) the required overpotential for hydrogen evolution relative to the overpotential required for the reduction of iron-based discharge products to metallic iron, and may do so in low concentrations suitable for cost-effective, large-scale implementation.

### Low-Concentration Additive Supported by the Anode

In the discussion that follows, all references are made to the negative electrode 102 of the electrochemical cell 100 for the sake of clear and efficient description and to avoid repetition. Unless otherwise specified or made clear from the context, the negative electrode 14 of the rechargeable battery 10 may include similar additives. Further, or instead, any one or more of the additives described herein may include one or more non-ferrous metals that may be recycled (e.g., for fabrication of new instances of the negative electrode 14) and/or disposed separately from iron of the negative electrode 14. Further, or instead, while additives supported on the anode may remain supported on the anode during cycling of the electrochemical cell between a charge mode and a discharge mode, it shall be appreciated that certain instances of additive formulations described herein may be dissolvable from the anode into the electrolyte during cycling of the electrochemical cell between a charge mode and a discharge mode.

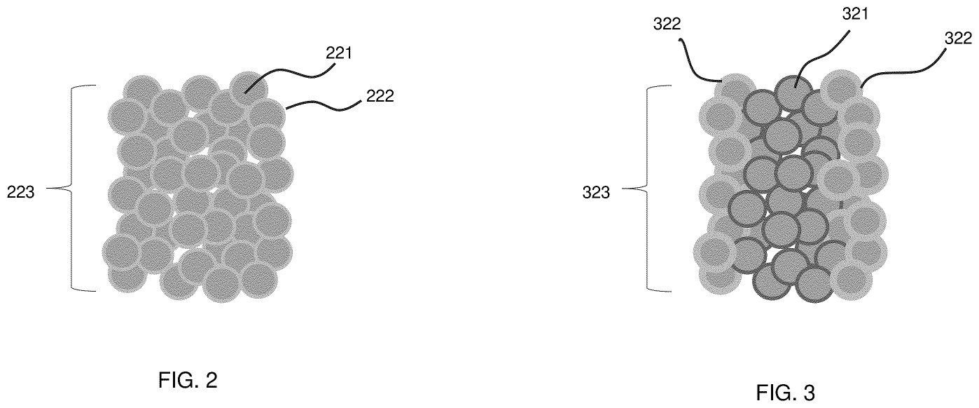

Further, in elements with numbers having the same last two digits in the description of FIGS. 2-4 that follows shall be understood to be analogous to or interchangeable with one another, unless otherwise specified or made clear from the context, and, therefore, are not described separately from one another, except to note differences and/or to emphasize certain features. For example, in the description that follows, an iron-containing active material 221, an iron containing active material 321, and an iron-containing active material 421 shall be understood to be analogous to and/or interchangeable with one another, unless a contrary intent is expressed or made clear from the context.

In some implementations, referring now to FIG. 1A and FIG. 2, the negative electrode 102 may include an iron containing active material 221 and an additive 222 reactive to inhibit hydrogen evolution in a charge state and in a resting state of the electrochemical cell 100, and the additive 222 in a concentration greater than about 10 and less than about 10,000 atoms of additive per million atoms iron of the iron-containing active material 221. The additive 222 may be substantially uniformly distributed in a porous structure 223 at least partially defined by the iron-containing active material 221. As used in this context, substantially uniform distribution of the additive 222 may include less than concentration of the additive 222 substantially uniform distribution with volumetric concentration of the additive in the anode varying by less than ±20 percent within the iron-containing active material 221 of the negative electrode 102 (e.g., varying by less than ±20 percent). For example, the additive 222 may include indium metal and such substantially uniform distribution may be achieve by heat treating the additive 222 before mixing with the iron-containing active material 221. Further, or instead, the additive 222 may include indium oxide, which may become substantially uniformly distributed throughout the porous structure 223 at least partially defined by the iron-containing active material as the iron oxide reduces to an iron metal during electrochemical cycling.

In some implementations, the additive 222 may be electrochemically active and, thus, deposit onto the iron during the lifetime of the battery to achieve a final incorporation state of the additive in the negative electrode. For example, precursor (e.g., an oxide and/or hydroxide) the additive 222 may be blended with the iron-containing active material 221, and the precursor may decompose during thermal treatment of the negative electrode 102 such that the final form of the additive 222 may be incorporated into the negative electrode 102. As an example, an oxide of the additive 222 may be blended with a polymer, which provides a carbon source to reduce the oxide into metal during thermal treatment. For example, the oxides of indium and lead are both reducible by carbon or hydrogen in the range of 700-900° C. and may be usefully converted from their oxides to their metals during a high temperature material processing step.

In certain implementations, referring now to FIG. 1A and FIG. 3, the negative electrode 102 may include an iron-containing active material 321 and an additive 322. The additive 322 may have a highest volumetric concentration along a surface of a porous structure 323 at least partially defined by the iron-containing active material 321. This may be useful, for example, for concentrating the additive 322 on a surface of the porous structure 323 on which the hydrogen evolution reaction may be most likely to occur. That is, concentrating the additive 322 on or near the surface of the porous structure 323 may facilitate mitigating the hydrogen evolution reaction using an efficient-that is, low-concentration-amount of the additive 322. The additive 322 may be wicked into the porous structure 323 according to any one or more of the various different wicking techniques described herein. For example, the iron-containing active material 321 may be sintered such that the porous structure 323 is solid and porous, and the additive 322 may be wicked into the porous structure 323 as a green body of the iron-containing active material 321 is sintered to form the porous structure 323.

In some implementations, the additive 322 may be added as a surface treatment to the porous structure 323 of the negative electrode 102. This may be particularly useful in instances in which the additive 322 has high wetting tendency on the iron-containing active material 321 and low melting temperature relative to iron. As an example, an aqueous suspension or solution of the additive 322 may be wicked into the porous structure 323, such as according to any one or more of the various different techniques described herein. Further, or instead, the additive 322 may be melted and wicked into the porous structure 323, as in the case of indium and lead.

Additionally, or alternatively, the negative electrode 102 may have a concentration gradient of the additive 322. For example, different locations of the porous structure 323 may include varying quantities of the additive 322. As a more specific example, larger concentrations of the additive 322 may be present near the surface of the porous structure 323. Further, or instead, larger concentrations of the additive 322 may be included in specific layers (e.g., where hydrogen evolution reaction is theoretically most likely) of the negative electrode 102. Possible manufacturing techniques may include separating varying levels/layers of concentration of the additive 322 by placing sheets between each layer or by spreading successive layers of powder with different compositions into a single layered structure. Continuing with this example of the sheets, slits may be formed in the side of a press used in fabrication of the negative electrode 102, and the sheets may be removed prior to heating. In some implementations, the additive 322 may have a crystal structure that is relatively open, as may be useful for facilitating doping. As an example, the additive 322 may include indium iron oxide. In certain implementations, the additive 322 may include a powder present only on the surface of the negative electrode.

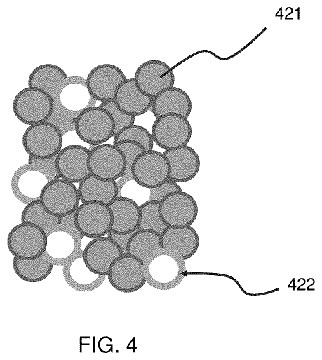

In implementations, referring now to FIG. 1A and FIG. 4, the negative electrode 102 may include an iron-containing active material 421 and an additive 422. For example, the additive 422 may include an alloy of an additive material and the iron-containing active material 421. For example, an indium metal powder mixed with iron powder and, in some instances, with zinc sulfide powder, and the mixture of these powers may be heated to form the additive 422. Such bonding in the solid state may be useful for reducing the likelihood of the additive 422 “coating” the iron-containing material 421, thus facilitating greater access to metallic iron.

Further, or instead, the additive 422 may be incorporated into the negative electrode 102 to impart predetermined mechanical properties to the negative electrode 102. For example, indium tin oxide nanorods may have high stiffness that provides enhanced mechanical properties to the negative electrode.

In some implementations, incorporating the additive into the negative electrode may include addressing instability of the additive. For example, cadmium evaporates before iron metallurgical processing temperatures, and the sulfide of cadmium is even less stable than zinc sulfide with respect to the direct reduction of iron and evaporation. Thus, in some instances, the additive may be incorporated into the negative electrode without heating (e.g., cold compressed anodes).

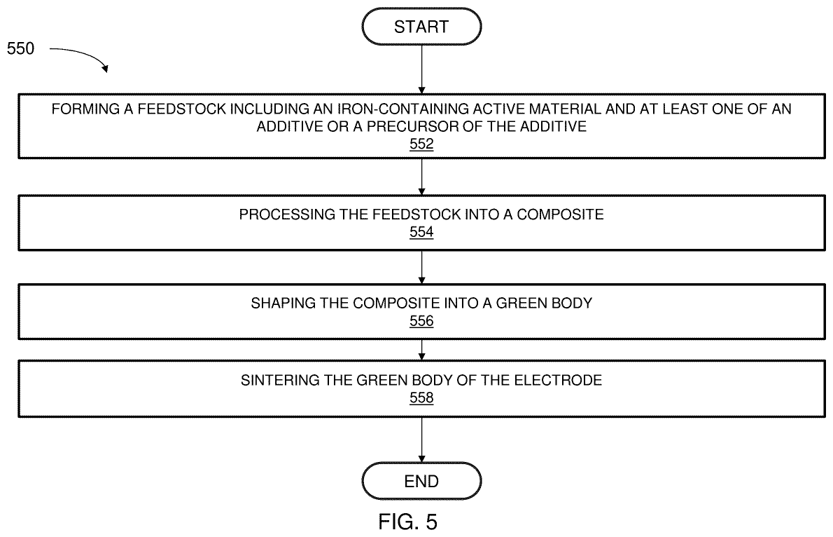

FIG. 5 is a flowchart of an exemplary method 550 of fabricating an electrode for an electrochemical cell. Unless otherwise specified or made clear from the context, it shall be appreciated that the exemplary method 550 may be used to form certain implementations of the negative electrode 102 of the electrochemical cell 100 (FIG. 1A) and/or the negative electrode 14 of the rechargeable battery 10 (FIG. 1B) including an iron-containing active material and one or more additives described herein. As an example, the exemplary method 550 may facilitate forming the negative electrode 102 of the electrochemical cell 100 (FIG. 1A) and/or the negative electrode 14 of the rechargeable battery 10 (FIG. 1B) with a low-concentration additive penetrated within a structure (e.g., a porous structure) at least partially defined by an iron-containing active material.

As shown in step 552, the exemplary method 550 may include forming a feedstock including an iron-containing active material and at least one of an additive or a precursor of the additive. The additive may be reactive to inhibit hydrogen evolution from the electrode under electrochemical cycling. As an example, forming the feedstock may include mixing the iron-containing active material and the additive together, such as tumble mixing, high shear mixing, or a combination thereof.

While the iron-containing active material and the at least one of the additive or the precursor of the additive may be mixed together in a single stage (e.g., in a final proportion), it shall be appreciated that the iron-containing active material and the at least one of the additive or the precursor of the additive may be mixed together in multiple stages, as may be useful for achieving a target distribution (e.g., substantially uniform distribution with volumetric concentration of the additive in the anode varying by less than ±20 percent within the anode) of the additive relative to the iron-containing active material. As an example, forming the feedstock may include mixing a powder of the iron-containing active material with the additive to form a mixture and heating the mixture to an elevated temperature greater than a melt temperature of the additive and less than a forging temperature of the iron-containing active material to form an additive-containing alloy. As a specific example, the powder may be iron powder and the additive include indium metal (e.g., a power of indium metal), and heating the mixture to the elevated temperature may include heating the mixture to 600° C. (e.g., for 2 to 10 hours). As described in greater detail below, the resulting indium-containing alloy may then be mixed and/or further processed with an additional amount of the iron-containing active material to achieve a target concentration of indium metal in an electrode including the iron-containing active material. In some instance, the indium, iron, and one or more other additive may be alloyed. Further, or instead, the alloy may include any one or more of the following: Aluminium-Scandium, Cerrosafe (lead, tin, cadmium), Rose metal (lead, tin), Wood's metal (lead, tin, cadmium), Al Ga (aluminum, gallium), Galfenol (iron), Galinstan, Field's metal (In, Bi, Sn), Solder, Terne, Type metal, Babbitt (copper, antimony, lead; used for bearing surfaces), Britannium (copper, antimony), Pewter (antimony, copper), Queen's metal (antimony, lead, and bismuth), Solder (lead, antimony), Terne (lead), and/or White metal.

As shown in step 554, the exemplary method 550 may include processing the feedstock into a composite in which the additive is distributed relative to the iron-containing active material. Further, or instead, the additive may be in a concentration greater than about 10 and less than about 10,000 atoms of additive per million atoms of iron in the composite. For example, the additive may be blended in larger concentrations than in the final form of the iron electrode to form a pre-treated material. This pre-treated material may be further mixed into more iron particles to achieve a target concentration of the additive that is lower than the concentration of the additive in the pre-treated material. The additive may be blended with iron as fine powder and thermally treated (e.g., at 150-900° C.) and, thus, incorporated into the negative electrode. As another example, the pre-treated material may be blended to be uniformly distributed in the iron material, with a predetermined ratio of treated-to-non-treated particles to achieve a target concentration in the final form of the iron electrode. The ratio of the treated-to-non-treated particles may be between 1:1 to 1:30 (e.g., 1:2 to 1:20 or 1:3 to 1:10). Further, or instead, the pre-treated material may be incorporated in discrete locations within the iron electrode, such as locations associated with hydrogen evolution (e.g., on the surface of the negative electrode).

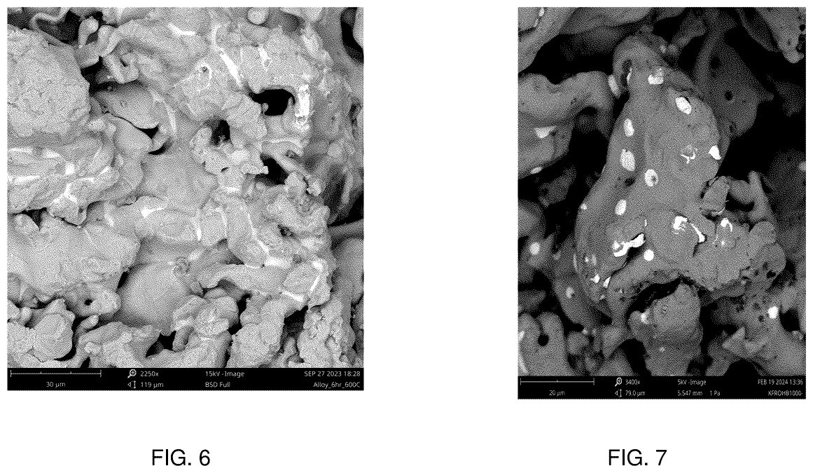

Returning to the example in which forming the feedstock includes forming an additive-containing alloy (e.g., an indium-containing alloy), processing the feedstock may include mixing the additive-containing alloy with an additional amount of the iron-containing active material such that concentration of the additive in the composite is at a target concentration (e.g., greater than about 10 and less than about 10,000 atoms of additive per million atoms of iron in the composite). FIG. 6 is a scanning electron microscope (SEM) image of an iron powder and indium metal alloy combined with a remainder of iron active material to form a green body.

Referring again to FIG. 5, forming the feedstock may include treating the iron-containing active material with a binder and/or a porosity forming material. Further, or instead, the additive may then be combined in a processing step (e.g., using high shear mixing) with the iron-containing material treated with the binder. The binder may include a polymer. The blending and bonding process of the additives to the iron powder may be performed with any of the methods known in the art for decorating a coarser powder with an additive powder. Powders produced from such processes are referred to under various names, such as binder-treated powder, resin-bonded powder, and bonded mixes. Binders and processes used for such treatment may be usefully applied to the bonding of additive particles to iron powders for iron negative electrodes. Binders may include a polar moiety for interacting with the iron surface (e.g., a stearate or stearamide group). Binders may further, or instead, include a non-polar moiety to lower melting temperatures and aid processability (e.g., an ethylene chain). Binders may still further or instead include a moiety designed to bond to the additive of interest (e.g., a polar group). Example binders may include ethylene bis stearamide, zinc stearate, and lithium stearate.

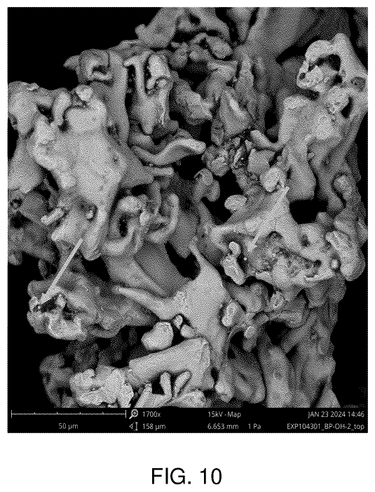

FIG. 9 is a scanning electron microscope (SEM) image of binder-treated iron treated combined, via mixing, with indium metal (light spot). FIG. 10 is a scanning electron microscope (SEM) image of binder-treated iron combined, via mixing, with indium hydroxide (indicated by arrows).

Additionally or alternatively to treating the additive such that the material is bonded in the solid state, a binder may be added to bond the additive to the iron powder in the iron electrode without the formation of direct bonds between the additive and the iron material.

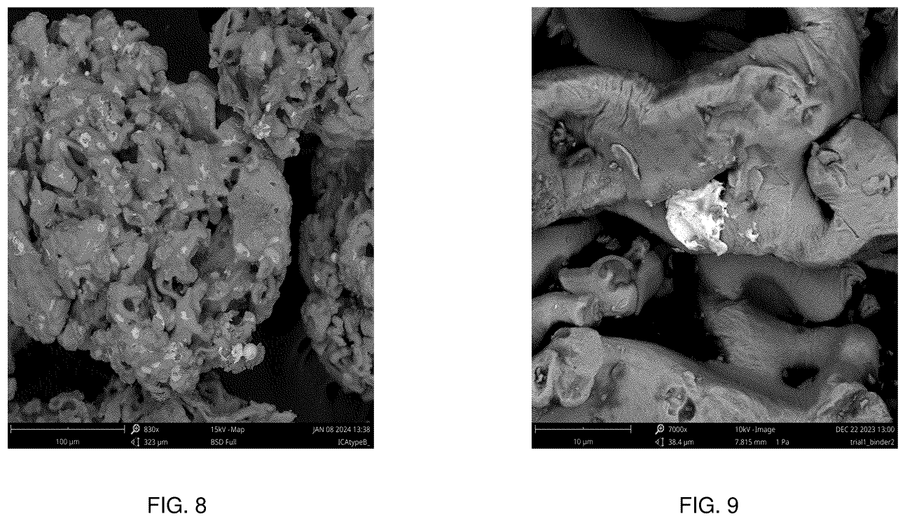

Referring again to FIG. 5, processing the feedstock into the composite may additionally, or alternatively, include wetting the additive onto the iron-containing active material. In certain implementations, wetting the additive on the iron-containing active material may include heating the feedstock to an elevated temperature greater than a melt temperature of the additive and less than a forging temperature of iron. As an example, the additive may be include indium metal, and the elevated temperature may be 200° C. or greater and 1200° C. or less. FIG. 7 is a scanning electron microscope (SEM) image of indium metal (light spots) wetted onto iron. Further, or instead, wetting the additive onto the iron-containing active material may include heating the feedstock to an elevated temperature greater than a reduction temperature of a precursor of the additive and less than a forging temperature of iron. As an example, indium hydroxide may be used as a precursor of the additive, and a mixture of the iron-containing active material and the indium hydroxide may be heated to 200° C. or greater and 1200° C. or less. FIG. 8 is a scanning electron microscope (SEM) image of indium hydroxide (light spots) wetted onto iron.

Referring again to FIG. 5, as shown in step 556, the exemplary method 550 may include shaping the composite into a green body of the electrode. For example, shaping the composite into the green body of the electrode may include introducing the composite into a die having a form factor of the electrode being formed.

In certain implementations the iron-containing active material may include an iron powder that is shaped into the green body. In various embodiments the iron powder may include a sponge iron powder, an iron oxide powder, an atomized iron powder, an iron hydroxide powder, or a combination thereof. Further, or instead, powdered forms of the additive that are added to the iron-containing material may be selected to have predetermined sizes relative to a powder of the iron-containing material. In some embodiments, the additive may be processed as a powder that has a much finer mean particle size than that of the powder of the iron-containing material that it is being mixed with to form the anode (e.g., either as a mixture of powders or in a sintered body). The finer mean particle size of the additive may facilitate more economical use of the additive by increasing the likelihood that the additive is able to be substantially homogeneously distributed throughout the mixture at low weight fractions while facilitating low path lengths from the iron-containing material to the nearest particle of the additive. The ratio of the mean particle size of the powder of the iron-containing material to the mean particle size of the additive may be between 6:1 and 500:1 (e.g., 10:1 to 250:1 or 12:1 to 200:1). Within these size ranges the powder size of the additive may be chosen based on cost and supply considerations, rather than the performance impacts of additive spatial distribution. In an example, metallic iron powders with D50's between 50 and 300 microns may be blended with indium hydroxide powders with D50's between 1 and 10 microns at weight fractions between 0.01 and 0.3 wt %. Further or instead, metallic iron powders with D50's between 50 and 300 microns may be blended with bismuth oxide powders with D50's between 1 and 10 microns at weight fractions between 0.01 and 2 wt %. Still further or instead, metallic iron powders with D50's between 50 and 300 microns may be blended with metallic indium powders with D50's between 1 and 10 microns at weight fractions between 0.01 and 0.2 wt %. Additionally, or alternatively, metallic iron powders with D50's between 50 and 300 microns may be blended with metallic bismuth powders with D50's between 1 and 10 microns at weight fractions between 0.01 and 0.2 wt %. Further, or instead, mixtures of such additives may be made with similar weight fractions and size characteristics. Still further, or instead, the additive powder may be bonded to the iron powder with solid state bonding or polymer bonding techniques described herein.

Unless otherwise specified or made clear from the context, any one or more of the fabrication techniques described herein for forming an anode (e.g., the negative electrode 102 of the electrochemical cell 100 in FIG. 1A or the negative electrode 14 of the rechargeable battery 10 in FIG. 1B) may form the anode with at least a portion of the iron-containing material defining a porous structure. Any one or more of the electrolytes described herein may penetrate the porous structure. Further, or instead, any one or more of the additive described herein may be supported on and/or within the porous structure to interact with the iron-containing active material and/or with the electrolyte.

In certain implementations, the iron-containing active material may include iron powder, and the porous structure of the anode may be defined by interstitial spaces between particles of the iron powder, and any one or more of the additives described herein may be distributed within the iron powder. To the extent the particles of the powder of the iron-containing active material are flowable relative to one another, the overall shape of the electrode may be retained by one or more support structures (e.g., by one or more instances of the current collector 107 in FIG. 1A) holding the iron powder and the additive in place as the electrode undergoes electrochemical cycling in an electrochemical cell (e.g., the electrochemical cell 100 in FIG. 1A or the rechargeable battery 10 in FIG. 1B).

In some instances, the additive may include a granulate mixed with the iron powder to facilitate achieving distribution of the additive throughout the iron powder. Among other things, the granulate of the additive may facilitate achieving an average particle size of the same order of magnitude of the average particle size of the iron powder such that a feedstock and/or composite including the iron powder and the granulate of the additive may flow together—that is, with a reduced likelihood of unintended settling of the additive, as compared to additives having fine particle sizes compared to the average particle size of the iron powder. As an example, the granulate may include indium metal, lead oxide, zinc sulfide, or a combination thereof.

As shown in step 558, the exemplary method 550 may include sintering the green body of the electrode. As used herein, unless otherwise specified or made clear from the context, sintering shall be understood to refer to the process of forming a solid and porous mass of material through heat and pressure without melting the iron-containing material to the point of liquefaction. Further, the resulting solid and porous mass of material formed by sintering shall be referred to herein as “sintered” material, consistent with conventional use of this term in the field of material science. Thus, for example, through sintering the green body of the electrode, at least a portion of the iron-containing active material of the anode may be sintered. At least a portion of the additive may be supported on or in the porous structure of the sintered iron-containing active material.

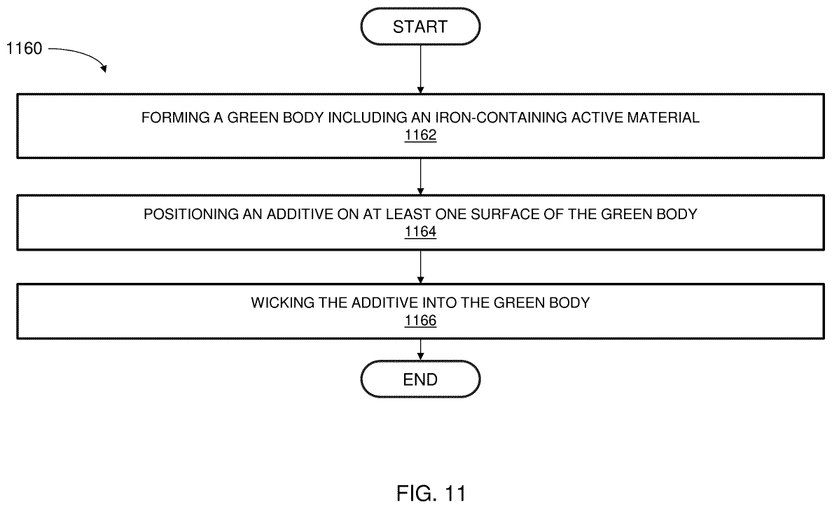

FIG. 11 is a flowchart of an exemplary method 1160 of fabricating an electrode of an electrochemical cell. Unless otherwise specified or made clear from the context, it shall be appreciated that the exemplary method 1160 may be used to form certain implementations of the negative electrode 102 of the electrochemical cell 100 (FIG. 1A) and/or the negative electrode 14 of the rechargeable battery 10 (FIG. 1B) including an iron-containing active material and one or more additives described herein. As an example, the exemplary method 1160 may facilitate forming the negative electrode 102 of the electrochemical cell 100 (FIG. 1A) and/or the negative electrode 14 of the rechargeable battery 10 (FIG. 1B) with a low-concentration additive disposed in the anode with a highest volumetric concentration of the additive in the anode along a surface of the anode.

As shown in step 1162, the exemplary method 1160 may include forming a green body including an iron-containing active material. For example, the green body may be formed according to certain aspects of the exemplary method 550 (FIG. 5). For example, the green body may include particles of an iron powder held together with a binder. As another example, the green body may include particles of an iron powder held in contact with one another in a die or other similar framework defining a form factor of an electrode being formed.

As shown in step 1164, the exemplary method 1160 may include positioning an additive (e.g., indium metal) on at least one surface of the green body. The additive may be any one or more of the various different additives described herein and further, or instead, may be reactive to inhibit hydrogen evolution from the electrode under electrochemical operation. As an example, positioning the additive on the at least one surface of the green body may include positioning a foil of the additive on the at least on surface of the green body. Further, or instead, positioning the additive on the at least one surface of the green body may include positioning a powder of the additive on the at least one surface of the green body. In some instances, the additive may include a low melting temperature metal (e.g., In, Cu, Pb, Ga, Cd and/or Bi) may be melted onto the surface of the electrode after or during fabrication of fabrication of the negative electrode.

As shown in step 1166, the exemplary method 1160 may include, with the additive positioned on the at least on surface of the green body, wicking the additive into the green body. For example, wicking the additive into the green body may include heating the additive and the green body to an elevated temperature greater than a melt temperature of the additive and less than a forging temperature of the iron-containing active material of the green body. As a specific example, heating the additive and the green body to the elevated temperature may be carried out as part of a sintering process of the green body such that the additive wicks into the green body as the green body sinters to form the green body into a solid and porous mass such that a highest volumetric concentration of the additive in the anode is along a surface of the sintered iron-containing material forming the anode. As used in this context, it shall be appreciated that the term “surface” refers to an outer surface of the anode, as distinguished from surfaces defined by inner porosity of the anode. As a still more specific example, the additive may be indium metal, and the additive and the green body may be heated to an elevated temperature of 200° C. or greater and 1200° C. or less.

### Low-Concentration Additive Dispersed in an Electrolyte

Referring again to FIG. 1B, low concentrations of compounds containing an additive may be dispersed in the electrolyte 20 such that the electrolyte 20 includes the additive plus any accompanying counterions facilitating additive dissolution. For example, the additive may include an oxide, a hydroxide, an oxyhydroxide, a nitrate, an acetate, a sulfate, a phosphate, a carbonate, and/or a sulfide of a non-ferrous metal or a mixture thereof. As a specific example, the additive may include lead acetate (e.g., greater than 0 mM and less than 0.005 mM lead acetate) dissolved in the electrolyte 20. Additionally, or alternatively, the additive may include indium nitrate dissolved in the electrolyte 20 (e.g., greater than 0 mM and less than 20 mM of indium nitrate) dissolved in the electrolyte 20. The anion of the additive may be organic and oxidizable such that it is decomposed at the counter electrode. This results in decreased solubility such that the non-ferrous metal may be deposited onto the anode.

From aqueous solution, the additives may unevenly deposit on the negative electrode 14 during charge, thus limiting the effectiveness of the additives with respect to inhibiting the hydrogen evolution reaction. Thus, in certain implementations, the ligations of a metal using an organic ligand may be used to alter the deposition rate of the additive on the negative electrode 14 and/or alter the properties of a film of the additive that forms on the negative electrode 14. As an example, deposition may be moderated with monodentate ligands such as cyanide, ammonia, acetate, hydrosulfide, taurine, hydroxamic acid, ethylenediamine and derivatives, EDTA, coordinating acetates, catechol and derivatives, and combinations thereof. In some implementations, the desired distribution of the additive may include large numbers of thin islands spread across the surface.

### Experimental Results

The following experiments demonstrate certain aspects of low-concentration additives in anodes including iron-containing material described herein. It is to be understood that these experiments and corresponding results are set forth by way of example only, and nothing in these examples shall be construed as a limitation on the overall scope of this disclosure.

### Example 1—Indium Nitrate

A baseline electrochemical cell included an electrolyte of 5.95 M KOH+0.05 M LiOH and a sintered iron electrode. The baseline electrochemical cell had a charge capacity of 500 mAh/g, and charge and discharge current density of 22.5 mA/cm². A test electrochemical cell included an electrolyte of 5.95 M KOH+0.05 LiOH+10 mM indium nitrate and a sintered iron electrode The test electrochemical cell had a charge capacity of 500 mAh/g, and a charge and discharge current density of 22.5 mA/cm².

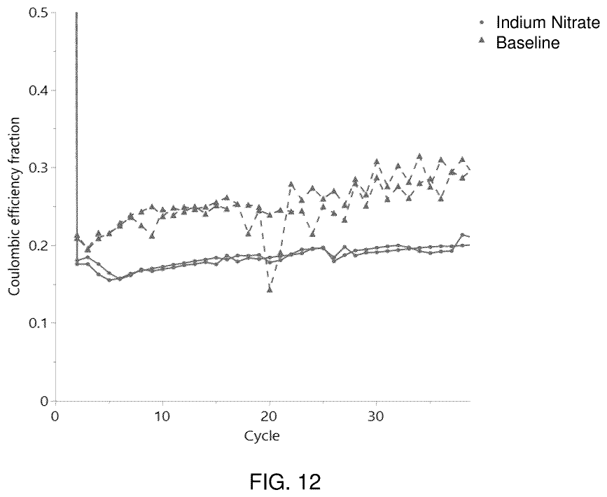

FIG. 12 is a graph of experimentally measured Coulombic efficiency fraction as a function of cycle number for the baseline electrochemical cell without an additive compared to the electrochemical cell including indium nitrate in an electrolyte. As may be appreciated from these results, the low-concentration of the indium nitrate in the test electrochemical cell significantly increases Coulombic efficiency fraction relative to that of the baseline electrochemical cell.

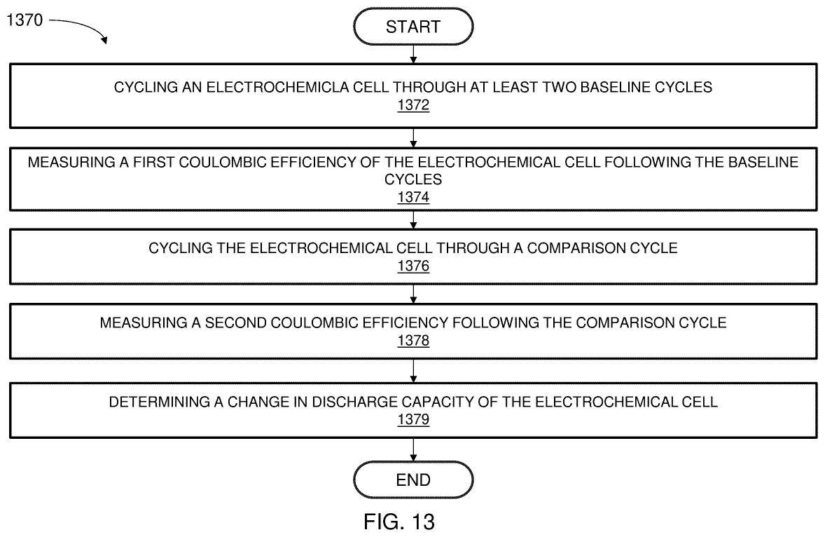

FIG. 13 is a flowchart of an exemplary method 1370 of static discharge testing of an electrochemical cell. Unless otherwise specified or made clear from the context, the exemplary method 70 may be carried out on any one or more of the various different electrochemical cells including an anode in ionic communication with a positive electrode (e.g., an air electrode) via an electrolyte. For example, the exemplary method 1370 may be used to test static discharge of any one or more of the electrochemical cells described herein, including the electrochemical cell 100 (FIG. 1A) and the rechargeable battery 10 (FIG. 1B). As used in this context, the term “static discharge” shall be understood to refer to a gradual loss of energy stored by an electrochemical cell when not in use—that is, during rest. It is generally useful to reduce static discharge of an electrochemical cell such that there is increased utilization of the iron-containing active material upon discharge.

As shown in step 1372, the exemplary method 1370 may include cycling the electrochemical cell through at least two baseline cycles. Each baseline cycle may include, for example, charging the electrochemical cell from a lower voltage limit to a predetermined target capacity and discharging the electrochemical cell from the predetermined target capacity to the lower voltage limit. Further, or instead, each of the baseline cycles may be similar to one another according to a predetermined acceptance criteria. Thus, for example, if two consecutive cycles do not meet the predetermined acceptance criteria, these two cycles are not used as the baseline cycles for carrying out the exemplary method 1370.

As shown in step 1374, the exemplary method 1370 may include measuring a first Coulombic efficiency of the electrochemical cell following the at least two baseline cycles.

As shown in step 1376, the exemplary method 1370 may include cycling the electrochemical cell through a comparison cycle. The comparison cycle may include charging the electrochemical cell from the lower voltage limit to the predetermined target capacity. With the electrochemical cell charged to the predetermined target capacity, interrupting electric current to the electrochemical cell for a predetermined rest period. The predetermined rest period may be any period of time useful for static discharge performance of the electrochemical cell in an end-use application and, in certain implementations, may be balanced against speed of testing. Thus, for example, for iron-air batteries, the predetermined rest period may be 24 hours or more and 72 hours or less (e.g., 48 hours). At the end of the predetermined rest period, the comparison cycle includes discharging the electrochemical cell to the lower voltage limit.

As shown in step 1378, the exemplary method 1370 may include measuring a second Coulombic efficiency following the comparison cycle.

As shown in step 1379, in the exemplary method 1370 may include, based on the first Coulombic efficiency and the second Coulombic efficiency, determining a change in discharge capacity of the electrochemical cell. For example, determining the change in discharge capacity of the electrochemical cell may include determining a rate of discharge capacity loss over time of the predetermined rest period. Further, or instead, the change in discharge capacity of the electrochemical cell corresponds to static discharge of the electrochemical cell and, among other things, may serve as a useful metric for assessing performance of an electrochemical cell. As shown in greater detail below, the change in discharge capacity may facilitate quantifying performance of low-concentration additives described herein.

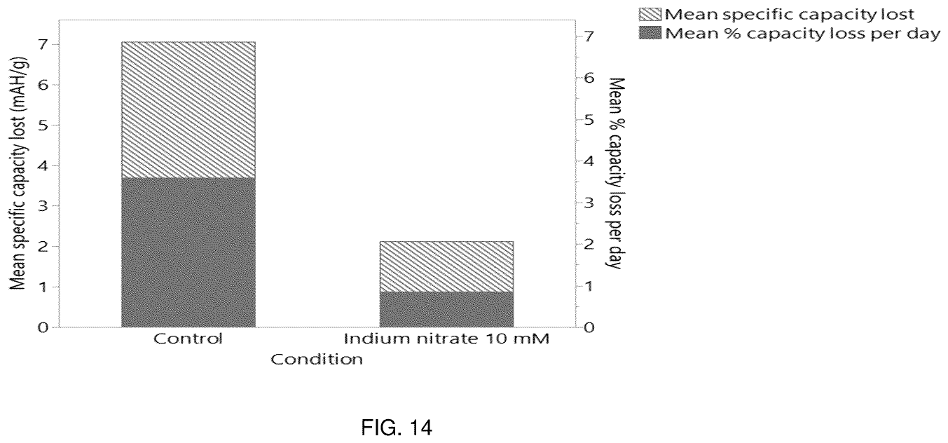

FIG. 14 is a bar chart of mean specific capacity lost (mAH/g) and mean percentage capacity loss per day experimentally determined according to the method FIG. 13 for the baseline electrochemical cell and the test electrochemical cell of Example 1. The mean was determined over several repeated static discharge tests. As may be appreciated from this bar chart, the addition of the low-concentration of indium nitrate significantly reduces (from about 7 percent to about 2 percent) the mean percentage capacity loss per day due to static discharge.

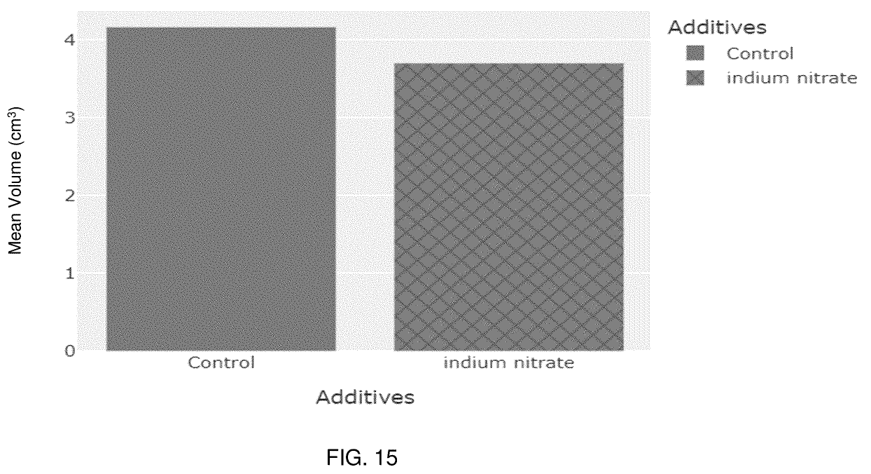

FIG. 15 is a bar chart of experimentally determined volume of hydrogen evolution for a baseline example of atomized iron powder in 6.5 M potassium hydroxide (KOH) as compared to atomized iron powder in 0.4 mM indium nitrate and 6.5 M potassium hydroxide (KOH). For this test, baseline electrolyte and iron were sealed in a first vial and the test electrolyte and iron were sealed in a second vial. The displacement of a plunger of an empty syringed was used to measure the volume of hydrogen evolved from each vial after 18 hours of incubation at 65° C. As may be appreciated from the bar chart, the low-concentration of indium nitrate appeared to reduce hydrogen evolution compared to the hydrogen evolution occurring the vial without the indium nitrate additive.

### Example 2—Indium Metal & Indium Oxide

A baseline electrochemical cell included an electrolyte of 6.5 M KOH+60 mM tin and a sintered iron electrode. The baseline electrochemical cell had a charge capacity of 600 mAh/g, and charge and discharge current density of 15 mA/cm². A first test electrochemical cell was the same as the baseline electrochemical cell except that the sintered iron electrode was formed from 500 ppm number indium metal powder mixed with iron powder. A second test cell was the same as the baseline electrochemical cell except that the sintered iron electrode was formed from 500 ppm number indium oxide powder mixed with iron power.

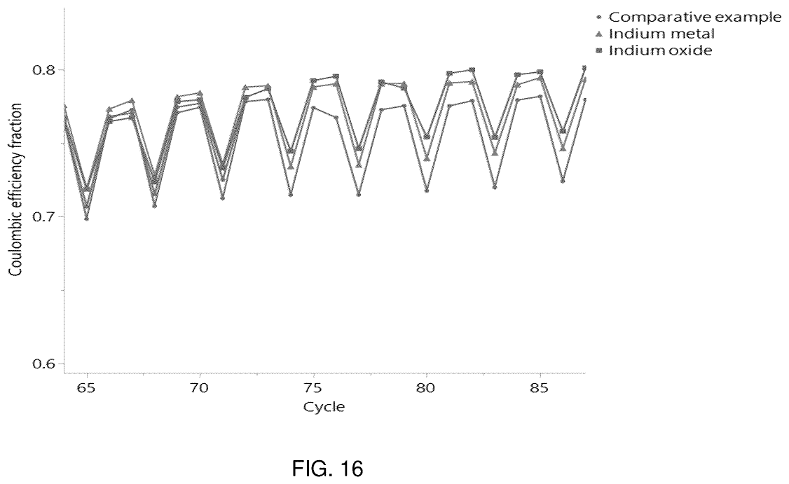

FIG. 16 is a graph of experimentally measured Coulombic efficiency fraction as a function of cycle number for a baseline electrochemical cell without an additive compared to an electrochemical cell including a sintered anode of indium metal and iron and to an electrochemical cell including a sintered anode of indium oxide and iron. As may be appreciated from these results, the low-concentration of the indium metal in the first electrochemical test cell and the low-concentration of the indium oxide in the second electrochemical test cell increases Coulombic efficiency fraction relative to that of the baseline electrochemical cell.

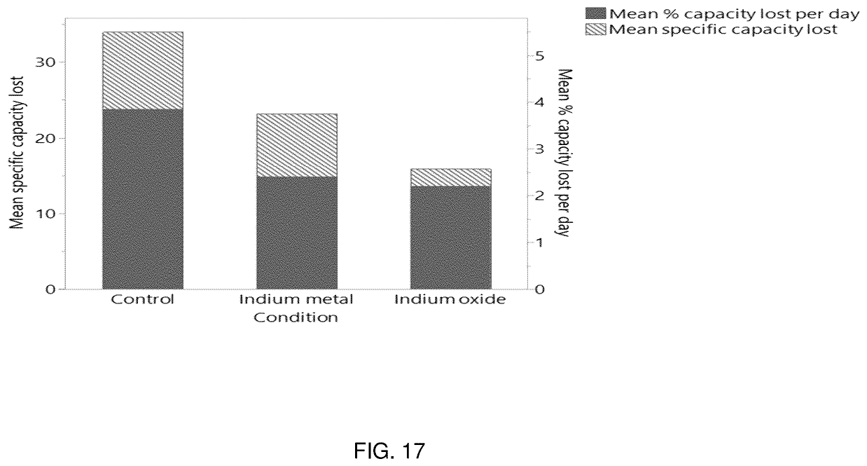

FIG. 17 is a bar chart of mean specific capacity lost (mAH/g) and mean percentage capacity loss per day experimentally determined according to the method FIG. 13 for a baseline electrochemical cell without an additive compared to the first test electrochemical cell and the second test electrochemical cell of Example 2. The mean was determined over several repeated static discharge tests. As may be appreciated from this bar chart, the addition of the low-concentration of indium metal and low-concentration indium oxide each significantly reduces) the mean percentage capacity loss per day due to static discharge as compared to that of the baseline electrochemical cell, with indium oxide appearing to be more effective than indium metal.

As another experiment, mean specific hydrogen current density was measured from a baseline electrochemical cell and a test electrochemical cell. The measurements were made with an in-line hydrogen sensor over a 48 hour rest at the top of charge. For this experiment, the baseline electrochemical cell included 6.5 M KOH+60 mM tin and a sintered iron electrode. The baseline electrochemical cell had a charge capacity of 500 mAh/g and charge and discharge current density of 22.5 mA/cm². The test electrochemical cell was the same as the baseline electrochemical cell, except that the test electrochemical cell included a sintered iron electrode formed from 1000 ppm number indium metal mixed with iron powder.

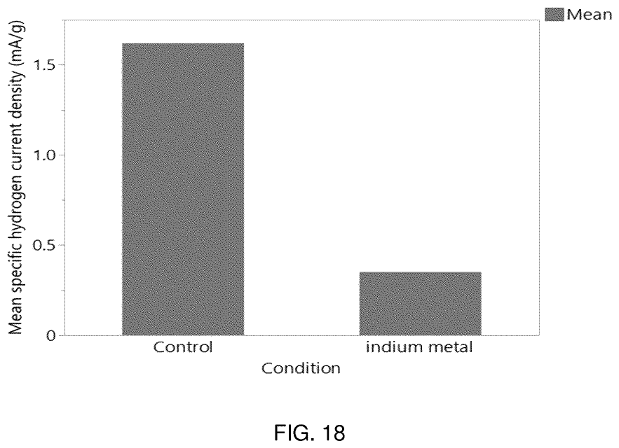

FIG. 18 is a bar chart of experimentally determined mean specific hydrogen current density (mA/g) for the baseline electrochemical cell without an additive compared to the test electrochemical cell including the low-concentration indium-metal additive. As may be appreciated from this bar chart, the low-concentration indium-metal additive significantly reduced the hydrogen current density from about 1.5 mA/g to less than 0.5 mA/g, measured over a 48 hour rest at top of charge of the respective electrochemical cells.

Collectively, the results of Example 1 and Example 2 suggest that an additive including greater than 200 mol indium/million mol iron and less than 2000 mol indium/million mol iron may have significant benefits for improving performance of electrochemical cell having an iron anode. Further, the results of Example 1 and Example 2 demonstrate that the tested low-concentration additives reduce the rate of self-discharge of an electrochemical cell by at least 10 percent compared to the rate of self-discharge of the electrochemical cell without the additive. Still further, the results of Example 1 and Example 2 demonstrate that, with the tested low-concentration additives, a mean percentage capacity of an electrochemical cell lost per day may be greater than zero and less than 4 percent.

### Example 3—Indium Hydroxide

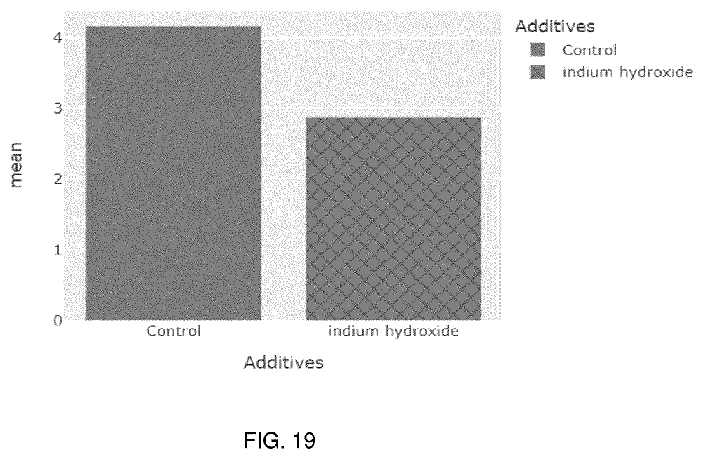

FIG. 19 is a bar chart of experimentally determined volume of hydrogen evolution for a baseline example of atomized iron powder in 6.5 M potassium hydroxide (KOH) as compared to atomized powder and indium hydroxide (1000 ppm number mol indium/million mol iron) in 6.5 M potassium hydroxide (KOH). For this test, baseline electrolyte and iron were sealed in a first vial and the test electrolyte and iron were sealed in a second vial. The displacement of a plunger of an empty syringed was used to measure the volume of hydrogen evolved from each vial after 18 hours of incubation at 65° C. As may be appreciated from the bar chart, the low-concentration of indium hydroxide appeared to reduce hydrogen evolution compared to the hydrogen evolution occurring the vial without the indium hydroxide additive.

### Example 4—Lead Acetate, Lead Sulfide, & Lead Oxide

A baseline electrochemical cell included an electrolyte of 6.5 M KOH+60 mM tin and a sintered iron electrode. The baseline electrochemical cell had a charge capacity of 600 mAh/g, and charge and discharge current density of 15 mA/cm². A first test electrochemical cell was the same as the baseline electrochemical cell except that the 0.0028 mM of lead acetate was dissolved in the electrolyte. A second test cell was the same as the baseline electrochemical cell except that the iron sintered anode was made with 2.14 mM lead sulfide.

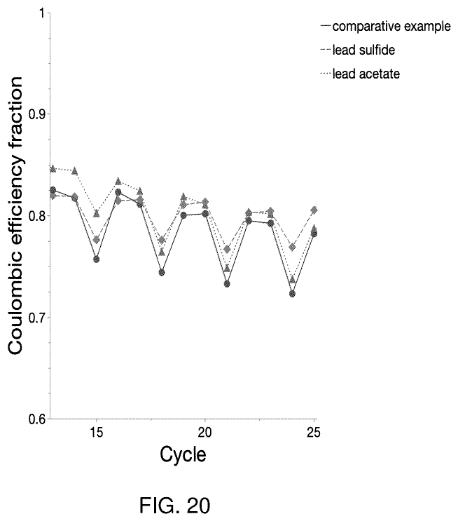

FIG. 20 experimentally measured Coulombic efficiency fraction as a function of cycle number for the baseline electrochemical cell without an additive compared to an electrochemical cell including an electrolyte with lead acetate as an additive and compared to an electrochemical cell include lead sulfide as an additive in the anode. As may be appreciated from these results, a low concentration of lead acetate and a low concentration of lead sulfide (e.g., greater than 0 mM and less than 5 mM lead sulfide) may each improved Coulombic efficiency of an electrochemical cell including an iron anode.

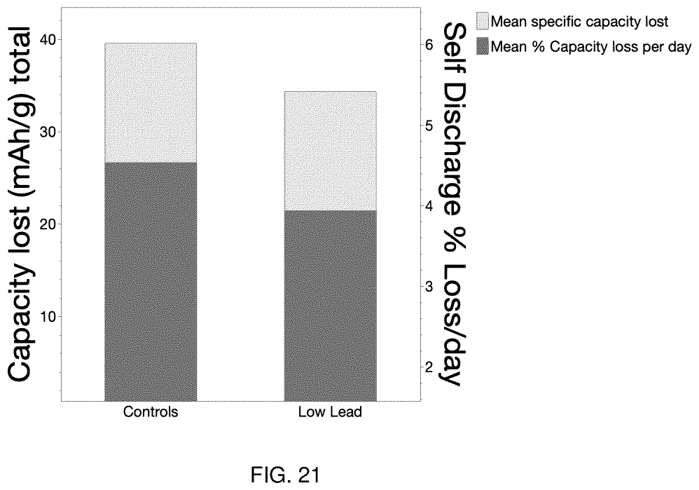

FIG. 21 is a bar chart of mean specific capacity lost (mAH/g) and mean percentage capacity loss per day experimentally determined according to the method FIG. 13 for the baseline electrochemical cell without an additive compared to the first test electrochemical cell with 0.0028 mM lead acetate dissolved in the electrolyte. The mean was determined over several repeated static discharge tests. As may be appreciated from this bar chart, the addition of the low-concentration of lead acetate in the electrolyte reduces the mean percentage capacity loss per day due to static discharge as compared to that of the baseline electrochemical cell.

As another experiment, a three-electrode setup with an iron foil working electrode was used to evaluate additive effects on hydrogen evolution reaction (HER) and iron reactions. The foil first underwent cyclic voltammetry in an HER dominant regime, and then in an iron reaction dominant regime. Corrosion metrics were determined from the data using Tafel kinetic assumptions. For these experiments, 0.001 wt % lead oxide was dissolved in a baseline electrolyte of 5.95 M KOH+0.05 M LiOH.

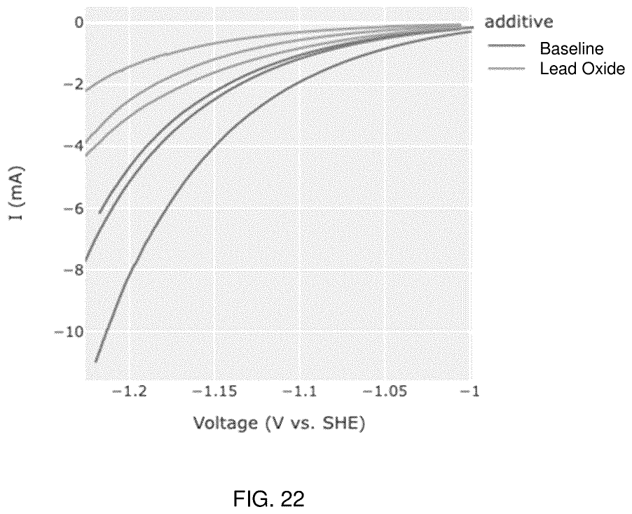

FIG. 22 is a graph of the cyclic voltammetry results of a three-electrode set-up with an iron foil using a baseline electrolyte without an additive compared to the same electrolyte with 0.001 wt % lead oxide added. As may be appreciated from these results, the low-concentration of lead oxide added to the electrolyte resulted in lower HER exchange current density. Thus, as suggested by these results, dissolving greater than 0 wt % and less than 0.005 wt % lead oxide in an electrolyte may be useful for improving performance of an electrochemical cell with an iron anode.

### Example 5—Antimony Acetate

A baseline electrochemical cell included an electrolyte of 6.5 M KOH+60 mM tin and a sintered iron electrode. The baseline electrochemical cell had a charge capacity of 556 mAh/g, and charge and discharge current density of 15 mA/cm². A first test electrochemical cell was the same as the baseline electrochemical cell except that 0.000028 mM antimony acetate was dissolved in the electrolyte.

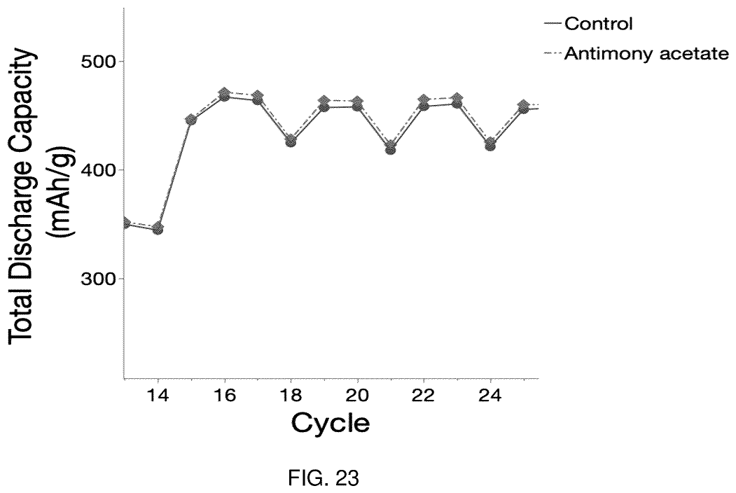

FIG. 23 is a graph of experimentally determined total discharge capacity as a function of cycle number for the baseline electrochemical cell without an additive compared to the electrochemical cell including an electrolyte with antimony acetate dissolved in the electrolyte. As may be appreciated from these results, low-concentration of antimony acetate improved Coulombic efficiency relative to a baseline electrochemical cell without an additive. These results suggest that an additive including greater than 0 mM and less than 0.000050 mM antimony acetate may be useful for improving performance of electrochemical cells including iron anodes.

The foregoing method descriptions are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not necessarily intended to limit the order of the steps; these words may be used to guide the reader through the description of the methods. Further, any reference to claim elements in the singular, for example, using the articles “a,” “an” or “the” is not to be construed as limiting the element to the singular.

The preceding description of the disclosed embodiments is provided to enable any person skilled in the art to make or use the described embodiment. Further, any step of any embodiment described herein can be used in any other embodiment. Various modifications to these embodiments will be readily apparent to those skilled in the art, and the generic principles defined herein may be applied to other embodiments without departing from the scope of the disclosure. Thus, the present disclosure is not intended to be limited to the embodiments shown herein but is to be accorded the widest scope consistent with the following claims and the principles and novel features disclosed herein.

What is claimed is:

1. An electrochemical cell comprising:
an electrolyte; and
an anode in the electrolyte, the anode including an iron-containing active material, at least one of the anode and the electrolyte including an additive reactive to inhibit hydrogen evolution in a charge state and in a resting state of the electrochemical cell, and the additive in a concentration greater than about 10 and less than about 10,000 atoms of additive per million atoms iron of the iron-containing active material.

2. The electrochemical cell of claim 1, wherein the additive includes one or more non-ferrous metal components.

3. The electrochemical cell of claim 2, wherein the one or more non-ferrous metal components include Sb, Bi, Cd, Hg, In, Cu, Pb, Ga, Sc, Ge, or combinations thereof.

4. The electrochemical cell of claim 2, wherein each of the one or more non-ferrous metal components is in one of an elemental form, an oxide, a hydroxide, an oxyhydroxide, a nitrate, an acetate, a sulfate, a phosphate, a carbonate, a chloride, or a sulfide form.

5. The electrochemical cell of claim 2, wherein the additive includes an alloy of the one or more non-ferrous metal components.

6. The electrochemical cell of claim 1, wherein the additive is dispersed in the electrolyte.

7. The electrochemical cell of claim 1, wherein the additive is supported on the anode, and the additive is dissolvable from the anode into the electrolyte during cycling of the electrochemical cell between a charge mode and a discharge mode.

8. The electrochemical cell of claim 1, wherein the additive is wetted on the iron-containing active material of the anode.

9. The electrochemical cell of claim 1, wherein the additive is disposed in the anode, and a highest concentration of the additive is along a surface of the anode.

10. The electrochemical cell of claim 1, wherein the iron-containing active material of the anode at least partially defines a porous structure.

11. The electrochemical cell of claim 1, wherein the electrolyte includes potassium hydroxide (KOH), sodium hydroxide, lithium hydroxide (LiOH), or a combination thereof.

12. The electrochemical cell of claim 1, wherein the additive reduces a rate of self-discharge of the electrochemical cell by at least 10 percent compared to the rate of self-discharge of the electrochemical cell without the additive.

13. The electrochemical cell of claim 1, wherein a mean percentage capacity of the electrochemical cell lost per day of is greater than zero and less than 4 percent.

14. The electrochemical cell of claim 1, wherein specific hydrogen current density of the electrochemical cell is greater than zero and less than 0.5 mA/g, measured over a 48 hour rest at top of charge of the electrochemical cell.

15. The electrochemical cell of claim 1, wherein the additive is substantially uniformly distributed in the anode with volumetric concentration of the additive in the anode varying by less than ±20 percent within the anode.

16. The electrochemical cell of claim 1, further comprising a positive electrode in ionic communication with the anode via the electrolyte.

17. A method of fabricating an electrode for an electrochemical cell, the method comprising:
forming a feedstock including an iron-containing active material and at least one of an additive or a precursor of the additive, the additive reactive to inhibit hydrogen evolution from the electrode under electrochemical cycling;
processing the feedstock into a composite, the additive distributed relative to the iron-containing active material in the composite, and additive in a concentration greater than about 10 and less than about 10,000 atoms of additive per million atoms of iron in the composite; and
shaping the composite into a green body of the electrode.

18. A method of fabricating an electrode for an electrochemical cell, the method comprising:
forming a green body including an iron-containing active material;
positioning an additive on at least one surface of the green body, the additive reactive to inhibit hydrogen evolution from the electrode under electrochemical operation; and
with the additive positioned on the at least one surface of the green body, wicking the additive into the green body.

19. A method of static discharge testing of an electrochemical cell, the method comprising:
cycling the electrochemical cell through at least two baseline cycles, each baseline cycle including charging the electrochemical cell from a lower voltage limit to a predetermined target capacity and discharging the electrochemical cell from the predetermined target capacity to the lower voltage limit;
measuring a first Coulombic efficiency of the electrochemical cell following the at least two baseline cycles;
cycling the electrochemical cell through a comparison cycle including
charging the electrochemical cell from the lower voltage limit to the predetermined target capacity,
with the electrochemical cell charged to the predetermined target capacity, interrupting electric current to the electrochemical cell for a predetermined rest period, and
at the end of the predetermined rest period, discharging the electrochemical cell to the lower voltage limit;
measuring a second Coulombic efficiency following the comparison cycle; and
based on the first Coulombic efficiency and the second Coulombic efficiency, determining a change in discharge capacity of the electrochemical cell.
